(19) United States
(12) Patent Application Publication
(10) Pub. No.: US 2017/0293696 A1
(43) Pub. Date: Oct. 12, 2017

(54) RELATED ENTITY DISCOVERY

(71) Applicant: Google Inc., Mountain View, CA (US)

(72) Inventors: Mike Bendersky, Sunnyvale, CA (US); Vijay Garg, Sunnyvale, CA (US); Sujith Ravi, Santa Clara, CA (US); Cheng Li, Ann Arbor, MI (US)

(21) Appl. No.: 15/095,517

(22) Filed: Apr. 11, 2016

(51) Int. Cl. G06F 17/30; G06N 99/00; G06Q 10/10

(52) U.S. Cl. CPC G06F 17/30958; G06F 17/3053; G06Q 10/1095; G06N 99/005

(57) ABSTRACT

A computing device may generate, a graph that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes. The computing device may perform label propagation to associate a distribution of labels with each of the plurality of nodes. The computing device may be configured to receive an indication of at least one of a feature of interest or an entity of interest. The computing device may further be configured to output an indication of one or more related entities that are related to the feature of interest or the entity of interest.

### BACKGROUND

Computing devices may often receive, from a particular user, indications of entities in which the user is interested. For example, a user may use a computing device to execute searches for entities, such as places, events, people, businesses, restaurants, and the like. The user may also provide indications that the user has attended an event or eaten at a restaurant, such as by checking into an event using a social media application or by placing an indication of an event into the user's calendar.

### SUMMARY

In one example, the disclosure is directed to a method. The method may include generating, by a computing device, a graph that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes. The method may further include performing, by the computing device, label propagation to propagate a plurality of labels across the graph to associate a distribution of labels with each of the plurality of nodes. The computing device is configured to: receive an indication of at least one of a feature of interest or an entity of interest, and output, for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

In another example, the disclosure is directed to a computing system that includes a memory and at least one processor. The at least one processor is communicatively coupled to the memory and may be configured to: generate a graph to be stored in the memory that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes; and perform label propagation to propagate a plurality of labels across the graph to associate a distribution of labels with each of the plurality of nodes.

In another example, the disclosure is directed to a method. The method may include receiving, by a computing device, an indication of at least one of a feature of interest or an entity of interest. The method may further include determining, by the computing device, one or more related entities that are related to the feature of interest or the entity of interest based at least in part on a respective distribution of labels associated with one of a plurality of feature nodes in a graph that represents the feature of interest or one of a plurality of entity node in the graph that represents the entity of interest, wherein the graph includes a plurality of node, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes, and wherein a plurality of labels are propagated via label propagation across the graph to associate a distribution of labels with each of the plurality of nodes. The method may further include outputting, by the computing device and for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

In another example, the disclosure is directed to a computing system that includes a memory and at least one processor. The at least one processor is communicatively coupled to the memory and may be configured to: receive an indication of at least one of a feature of interest or an entity of interest; determine one or more related entities that are related to the feature of interest or the entity of interest based at least in part on a respective distribution of labels associated with one of a plurality of feature nodes in a graph that represents the feature of interest or one of a plurality of entity node in the graph that represents the entity of interest, wherein the graph includes a plurality of node, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes, and wherein a plurality of labels are propagated via label propagation across the graph to associate a distribution of labels with each of the plurality of nodes; and output, for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that is configured to determine related entities, in accordance with one or more aspects of the present disclosure.

FIG. 2 is a block diagram illustrating an example computing system that is configured to determine the level of relatedness of a set of entities, in accordance with one or more aspects of the present disclosure.

FIGS. 3A-3C are block diagrams each illustrating an example feature-entity bipartite graph that an example ranking module may construct to perform an exemplary expander technique according to aspects of the present disclosure.

FIG. 4 is a flowchart illustrating an example process for to determining related entities, in accordance with one or more aspects of the present disclosure.

FIG. 4 is a flowchart illustrating an example process for to determining related entities, in accordance with one or more aspects of the present disclosure.

### DETAILED DESCRIPTION

In general, techniques of this disclosure may enable a computing system to determine, for an entity, one or more related entities. The computing system may, for an entity of interest, determine one or more entities that are semantically related to the entity of interest, and may rank the one or more entities based at least in part on their relatedness to the entity of interest. Thus, if the computing system determines that a user is interested in an entity, the computing system may determine that the user may potentially also be interested in the one or more entities that are semantically related to the entity in which the user is interested. In this way, the computing system may provide to the user suggested entities in which the user may be interested.

The relatedness of two entities may be proportional to the probability of a random user that is interested in a first entity also being interested in the second entity. The computing system may determine the relatedness of an entity to each of a plurality of entities, and may generate a ranked list of the plurality of entities based at least in part on the degree to which the entity relates to each of the plurality of entities.

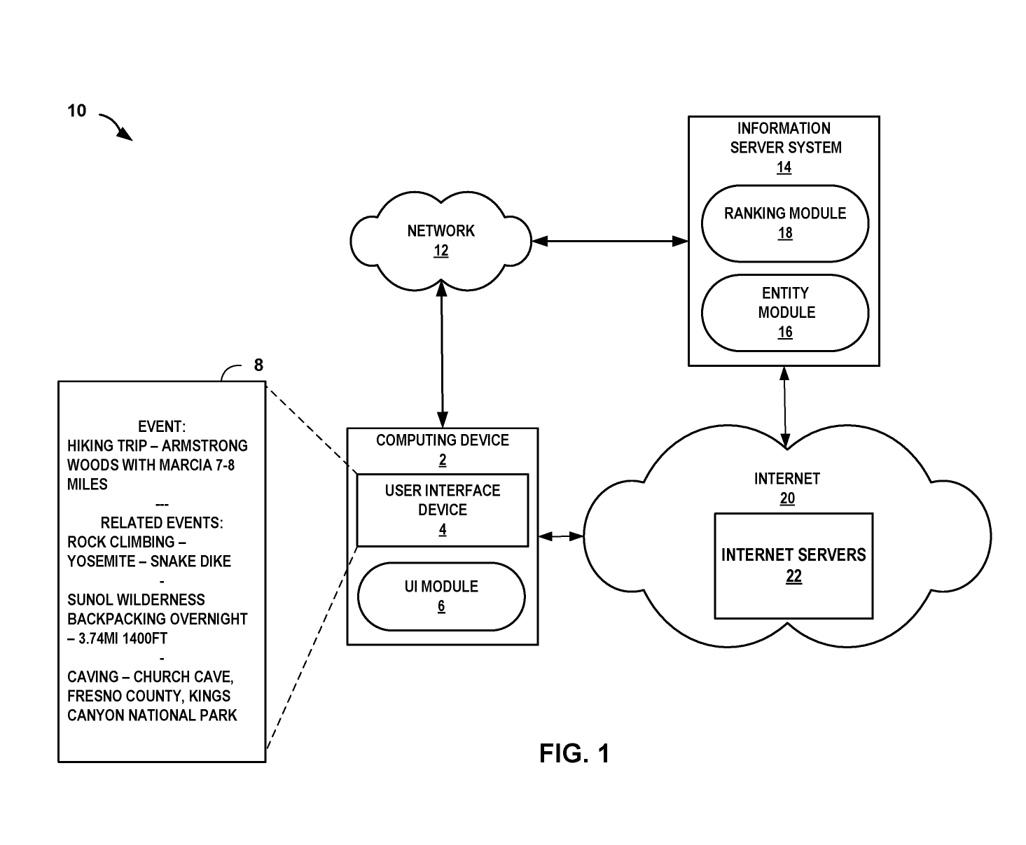

FIG. 1 is a conceptual diagram illustrating system 10 as an example system that may be configured to determine related entities, in accordance with one or more aspects of the present disclosure. System 100 includes information server system (“ISS”) 14 in communication with computing device 2 via network 12. Computing device 2 may communicate with ISS 14 via network 12 to provide ISS 14 with information that indicates a query received by computing device 2 or an entity in which a user of computing device 2 is interested. ISS 14 may generate a ranked list of one or more entities that are relevant to the query or entity and may communicate the ranked list of one or more entities to computing device 2. Computing device 2 may output, via user interface device 4, the ranked list of one or more entities for display to the user of computing device 2.

Network 12 represents any public or private communications network, for instance, cellular, Wi-Fi, and/or other types of networks, for transmitting data between computing systems, servers, and computing devices. Network 12 may include one or more network hubs, network switches, network routers, or any other network equipment, that are operatively inter-coupled thereby providing for the exchange of information between ISS 14 and computing device 2. Computing device 2 and ISS 14 may transmit and receive data across network 12 using any suitable wired or wireless communication techniques. In some examples, network 12 may be Internet 20.

ISS 14 and computing device 2 may each be operatively coupled to network 12 using respective network links. The links coupling computing device 2 and ISS 14 to network 12 may be Ethernet or other types of network connection(s), and such connections may be wireless and/or wired connections.

Computing device 2 represents an individual mobile or non-mobile computing device. Examples of computing device 2 include a mobile phone, a tablet computer, a laptop computer, a desktop computer, a server, a mainframe, a set-top box, a television, a wearable device (e.g., a computerized watch, computerized eyewear, computerized gloves), a home automation device or system (e.g., an intelligent thermostat or home assistant), a personal digital assistants (PDA), portable gaming systems, media players, e-book readers, mobile television platforms, automobile navigation and entertainment systems, or any other types of mobile, non-mobile, wearable, and non-wearable computing devices configured to receive information via a network, such as network 12.

Computing device 2 includes user interface device (UID) 4 and user interface (UI) module 6. UI module 6 may perform operations described using software, hardware, firmware, or a mixture of hardware, software, and firmware residing in and/or executing at respective computing device 2. In some examples, computing device 2 may execute UI module 6 with one or more processors or one or more devices. In some examples, computing device 2 may execute UI module 6 as one or more virtual machines executing on underlying hardware. In some examples, UI module 6 may execute as one or more services of an operating system or computing platform. In some examples, UI module 6 may execute as one or more executable programs at an application layer of a computing platform.

UID 4 of computing device 2 may function as an input and/or output device for computing device 2. UID 4 may be implemented using various technologies. For instance, UID 4 may function as an input device using one or more presence-sensitive input components, such as resistive touchscreens, surface acoustic wave touchscreens, capacitive touchscreens, projective capacitance touchscreens, pressure sensitive screens, acoustic pulse recognition touchscreens, or another presence-sensitive display technology. In addition, UID 4 may include microphone technologies, infrared sensor technologies, or other input device technology for use in receiving user input.

UID 4 may function as output (e.g., display) device using any one or more display components, such as liquid crystal displays (LCD), dot matrix displays, light emitting diode (LED) displays, organic light-emitting diode (OLED) displays, e-ink, or similar monochrome or color displays capable of outputting visible information to a user of computing device 2. In addition, UID 4 may include speaker technologies, haptic feedback technologies, or other output device technology for use in outputting information to a user.

UID 4 may include a presence-sensitive display that may receive tactile input from a user of computing device 2. UID 4 may receive indications of tactile input by detecting one or more gestures from a user (e.g., the user touching or pointing to one or more locations of UID 4 with a finger or a stylus pen). UID 4 may present output to a user, for instance at a presence-sensitive display. UID 4 may present the output as a graphical user interface (e.g., user interface 8), which may be associated with functionality provided by computing device 2. For example, UID 4 may present various user interfaces (e.g., user interface 8) related to a set of entities in which the user of computing device 2 may have an interest as provided by UI module 120 or other features of computing platforms, operating systems, applications, and/or services executing at or accessible from computing device 2 (e.g., electronic message applications, Internet browser applications, mobile or desktop operating systems, etc.).

UI module 6 may manage user interactions with UID 4 and other components of computing device 2 including interacting with ISS 14 so as to provide an indication of one or more entities at UID 4. UI module 6 may cause UID 4 to output a user interface, such as user interface 8 (or other example user interfaces) for display, as a user of computing device 2 views output and/or provides input at UID 4. UI module 6 and UID 4 may receive one or more indications of input from a user as the user interacts with the user interface. UI module 6 and UID 4 may interpret inputs detected at UID 4 and may relay information about the inputs detected at UID 4 to one or more associated platforms, operating systems, applications, and/or services executing at computing device 2, for example, to cause computing device 2 to perform functions.

UI module 6 may receive information and instructions from one or more associated platforms, operating systems, applications, and/or services executing at computing device 2 and/or one or more remote computing systems, such as ISS 14. In addition, UI module 6 may act as an intermediary between the one or more associated platforms, operating systems, applications, and/or services executing at computing device 2, and various output devices of computing device 2 (e.g., speakers, LED indicators, audio or electrostatic haptic output device, etc.) to produce output (e.g., a graphic, a flash of light, a sound, a haptic response, etc.) with computing device 2.

UI module 6 may receive an indication of an entity that the user of computing device 2 has an interest in. An entity may be, in some examples, an event, a place, a person, a business, a movie, a restaurant, and the like. For example, the user of computing device 2 may use a web browser application running on computing device 2 to visit a web page for a particular event (e.g., a web page for a rock climbing trip), or to “like” a social media post for the particular event, which may indicate to UI module 6 that the user is interested in the particular event.

UI module 6 may send an indication of the entity of interest to ISS 14 via network 12. For example, UI module 6 may send the Internet address (e.g., uniform resource locator) of the webpage for the entity. In response, UI module 6 may receive, via network 12, indications of one or more entities that are most related to the entity of interest from ISS 14. For example, UI module 6 may receive the Internet addresses of the one or more entities. UI module 6 may also receive from ISS 14 an indication of the level of relatedness of the one or more entities to the entity of interest, such as a ranking of how related each of the one or more entities are to the entity of interest or a numerical quantification (e.g., from 0 to 1.0) of the level of relatedness of each of the one or more entities to the entity of interest.

UID 4 may output user interface 8, such as a graphical user interface, that includes indications of the one or more entities related to the entity of interest. As shown in FIG. 1, if the entity of interest is a hiking trip, user interface 8 may include indications of a rock climbing event, a backpacking event, and a caving event as the entities that are related to the hiking trip. UID 4 may present the related entities in order of relatedness to the entity of interest in the non-limiting example of FIG. 1, such that the rock climbing event may be the most related entity, the backpacking event may be the next most related entity, and the caving event may be the third most related entity. In this way, UID 4 may present a ranked list of entities that the user of computing device 2 may be interested in based on the user's interest in the particular hiking trip.

In the example of FIG. 1, ISS 14 includes entity module 16 and ranking module 18. Together, modules 16 and 18 may be related entities services accessible to computing device 2 and other computing devices connected to network 12 for providing one or more entities that are related to an entity of interest. Modules 16 and 18 may perform operations described using software, hardware, firmware, or a mixture of hardware, software, and firmware residing in and/or executing at ISS 14. ISS 14 may execute modules 16 and 18 with one or more processors, one or more devices, virtual machines executing on underlying hardware, and/or as one or more services of an operating system or computing platform, to name only a few non-limiting examples. In some examples, modules 16 and 18 may execute as one or more executable programs at an application layer of a computing platform of ISS 14.

Entity module 16 may retrieve and/or receive, from Internet 20, Internet resources associated with entities, and may extract a set of features associated with each of the entities from the associated internet resources. Entity module 16 may crawl Internet 20 for Internet resources such as web pages, social media posts, and the like stored on internet servers 22 (e.g., web servers), or may otherwise receive a set of Internet resources, and may extract features from such Internet resources. For example, an Internet resource associated with a hiking trip may be a web site or social media post that describes the hiking trip.

In one example, entity module 16 may extract, from one or more web pages for an entity, one or more features associated with the entity. Features associated with an entity may be contextual information that describes the associated entity. Features may include text, such as words, phrases, and the like contained in the web pages for the entity. In some examples, features may also include images, videos, and other media. Entity module 16 may extract, from a web page for an entity, features such as an entity description, the surrounding text in the web pages, queries associated with the web pages on which the entities occur, anchor text pointed to the web pages for the entity, taxonomic categorization of the web pages for the entity, and the like.

Entity module 16 may store the features extracted from the Internet resources as well as indications of the associations between entities and the features onto computer readable storage devices, such as disks, non-volatile memory, and the like, in information server system 14. For example, entity module 16 may store such features and indications of the associations between entities and the features as one or more documents, database entries, or other structure data, including but not limited to comma separated values, relational database entries, eXtensible Markup Language (XML) data, JavaScript Object Notation (JSON) data, and the like.

Entity module 16 may also perform feature preparation on the set of features associated with each entity that are extracted from Internet resource associated with the respective entity. For example, entity module 16 may perform stop word removal to remove the most common words in a language (e.g., a, the, is, at, which, on, and the like for the English language). Entity module 16 may perform feature reweighting to weigh the features associated with the entity based at least in part on the frequency in which the feature appears in the Internet resource associated with the entity. For example, entity module 16 may assign a higher weight to features that appear more frequently in the Internet resource associated with the entity. Entity module 16 may store such weights of features for entities onto computer readable storage devices in ISS 14 as one or more documents, database entries, or other structure data, including but not limited to comma separated values, relational database entries, XML data, JSON data, and the like.

Ranking module 18 may receive an indication of an entity of interest from computing device 2, determine a ranking of one or more entities that are related to the entity of interest based at least in part on the level of relatedness of each of the one or more entities to the entity of interest, and communicate an indication of the one or more entities to computing device 2. To that end, ranking module 18 may determine a measure of similarity between the entity of interest and each of a plurality of other entities, where the measure of similarity may correspond to the level of relatedness, and may determine which of the plurality of other entities are the most related to the entity of interest based at least in part on the measure of similarity.

In one example, ranking module 18 may determine a measure of similarity between two entities based at least in part on measuring the similarity between features of two entities, and combining the measure of similarity between each feature type of the two entities. To determine a measure of similarity between an entity of interest and a target entity, ranking module 18 may, for features of each feature type associated with the entity of interest, determine the measure of similarity between the features of the feature type of the entity of interest and the features of the feature type of a target entity, and may combine the measure of similarity for each of the feature types of the entity to determine a measure of similarity between the entity of interest and the target entity.

In another example, ranking module 18 may determine a measure of similarity between two entities (e.g., an entity of interest and a target entity) based at least in part on whether the two entities share connections to other similar entities. In other words, ranking module 18 may determine that two entities are related because some of their associated features are semantically related, even if the two entities do not share the same features.

To this end, in accordance with aspects of the present disclosure, ranking module 18 may, in various non-limiting examples, generate a bipartite graph, where ranking module 18 may propagate information through the graph to pass semantic messages. Specifically, the bipartite graph may include a plurality of entity nodes associated with a plurality of entities that are connected to a plurality of feature nodes associated with a plurality of features, where each of the plurality of entity nodes is connected to one or more of the plurality of feature nodes. Thus, in the bipartite graph, an entity node that is associated with an entity may be connected to one or more feature nodes associated with the one or more features of the entity.

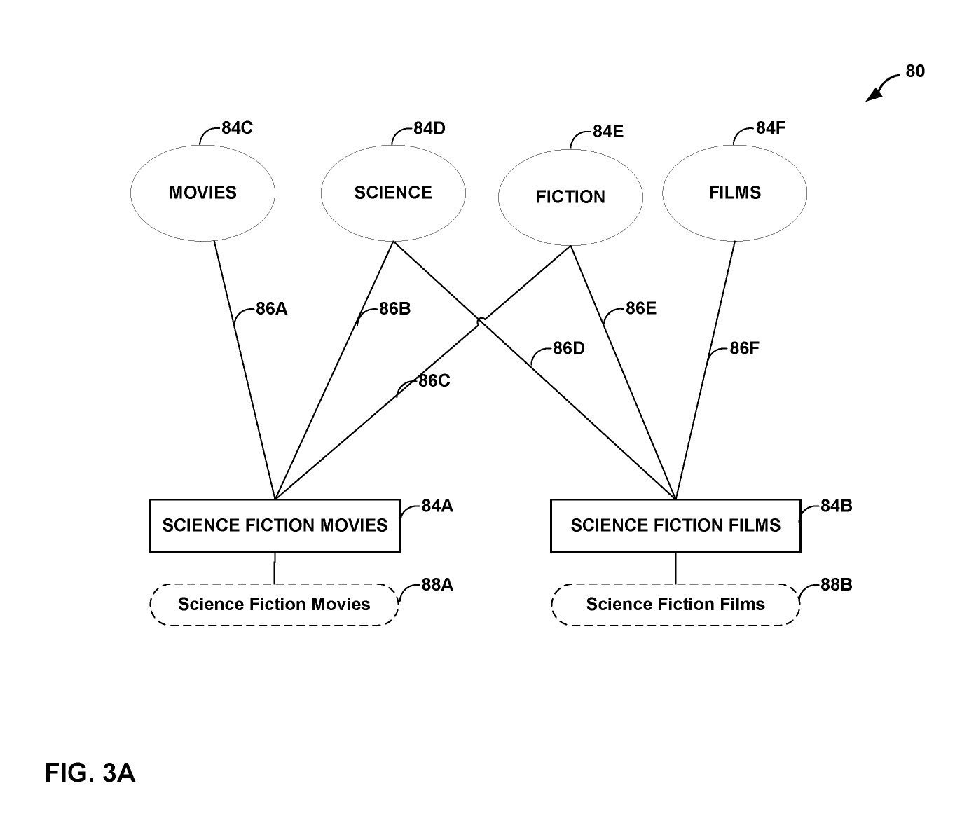

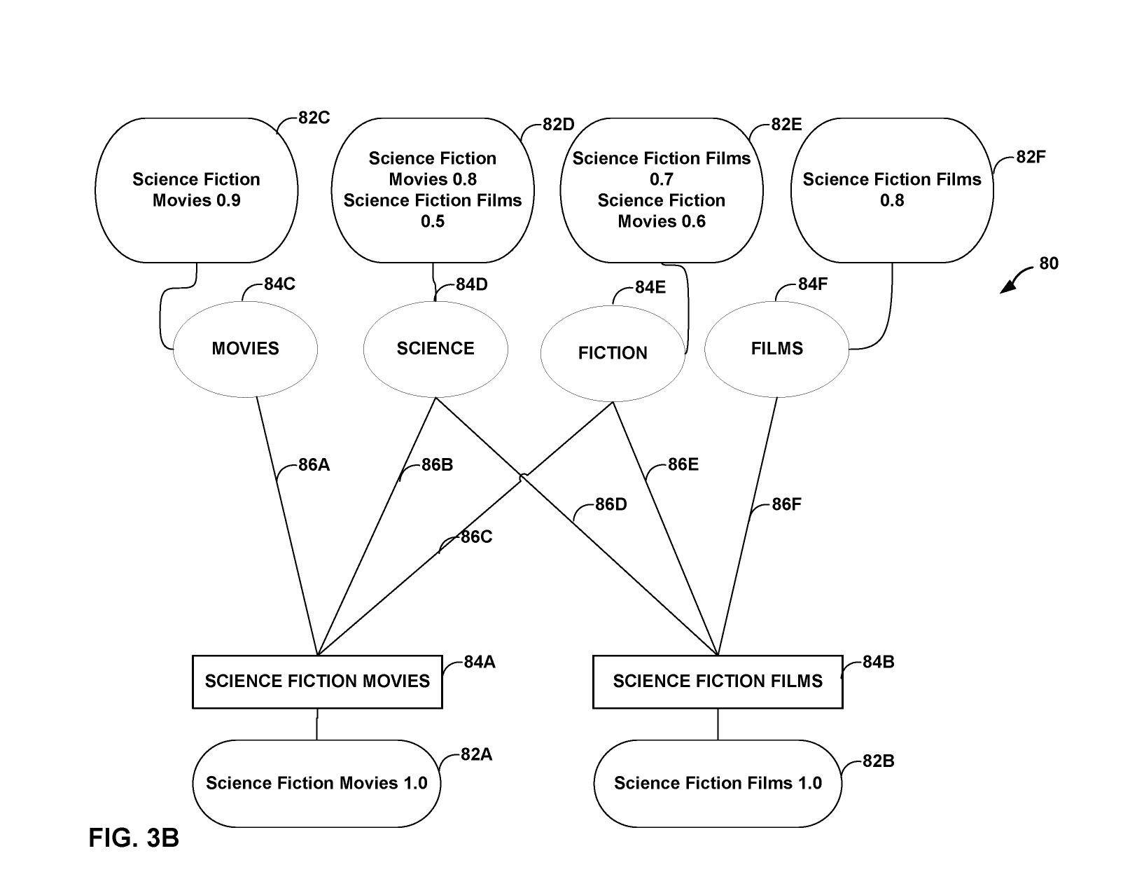

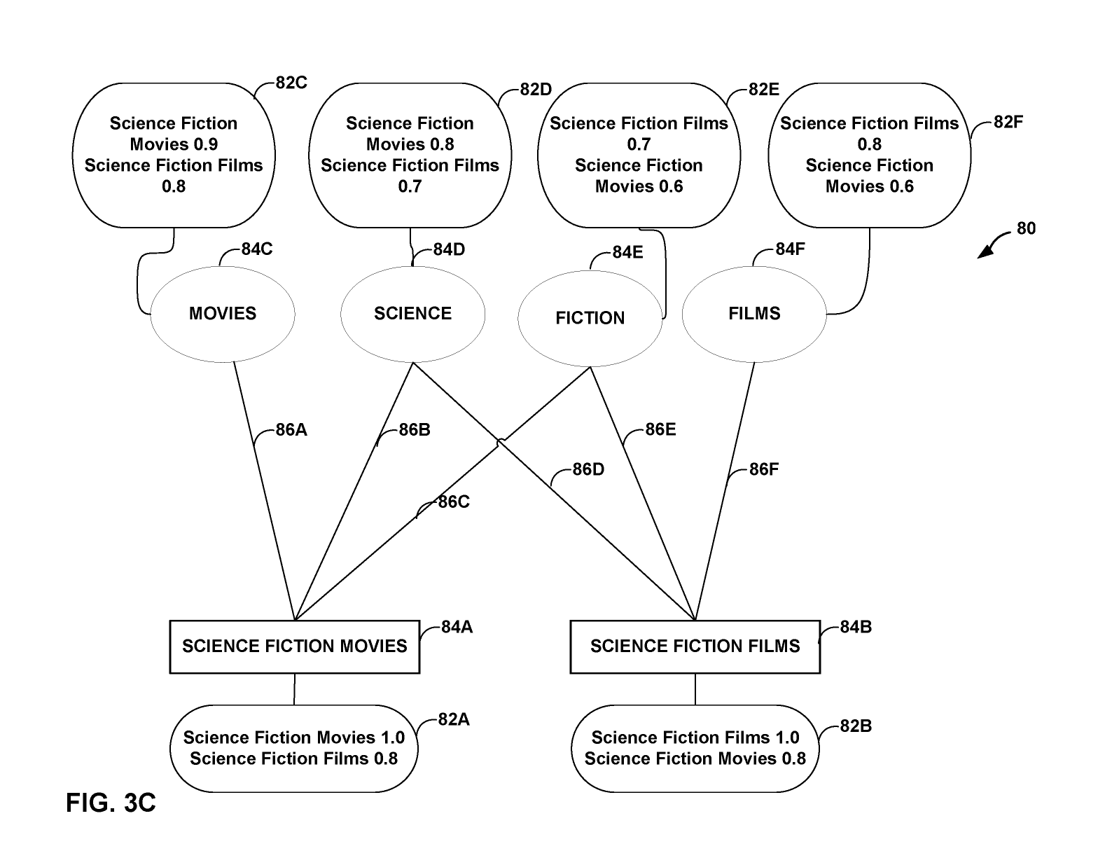

Ranking module 18 may determine, for an entity of interest, one or more related entities based at least in part on connections in the bipartite graph between one or more entity nodes associated with the one or more related entities to an entity node associated with the entity of interest. Specifically, ranking module 18 may perform unsupervised machine learning, including performing label propagation over multiple iterations to associate a distribution of labels with each of the plurality of nodes of the bipartite graph, as discussed in more detail below with respect to FIGS. 3A-3C. Ranking module 18 may perform such label propagation as an optimal solution that minimizes an objective function to generate a distribution of labels that is associated with each node of the bipartite graph, where each of the distribution of labels includes an indication of a ranking of one or more entities that are related to an entity or a feature represented by an associated entity node or feature node. In this way, ranking module 18 may determine, for a particular entity of interest, a ranking of one or more entities that are related to the entity of interest.

While described in terms of bipartite graphs, aspects of the present disclosure may be implemented as tables, databases, or other underlying data structure. Nodes and edges of a bipartite graph may thus also be implemented as portions of a data structure, entries in tables, databases, functions, transformations, or data applied to or between entries in tables, databases, or other underlying data structure. The data structures, tables, databases, functions, data, and so forth may thus represent one or more bipartite graphs as disclosed herein.

Ranking module 18 may perform the techniques above to determine a measure of similarity (e.g., a similarity score) between the entity of interest and a plurality of other entities, and may determine, based upon the determined measure of similarity, a ranking of the relatedness of the plurality of entities to the entity of interest. Ranking module 18 may send, via network 12 to computing device 2 an indication of a ranked list of one or more of the most related entities to the entity of interest. For example, ranking module 18 may send to computing device 2 a web page that includes links to the web pages associated with the ranked list of one or more of the most related entities. Correspondingly, a web browser running on computing device 2 may render the received web page such that UI device 4 may present user interface 8 that includes links to the web pages associated with the ranked list of one or more of the most related entities.

In accordance with aspects of the present disclosure, ISS 14 may generate a graph that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes. ISS 14 may perform label propagation to propagate a plurality of labels across the graph to associate a distribution of labels with each of the plurality of nodes. ISS 14 may receive an indication of at least one of a feature of interest or an entity of interest. ISS 14 may output for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest. These and other aspects of the present disclosure are discussed in more detail below.

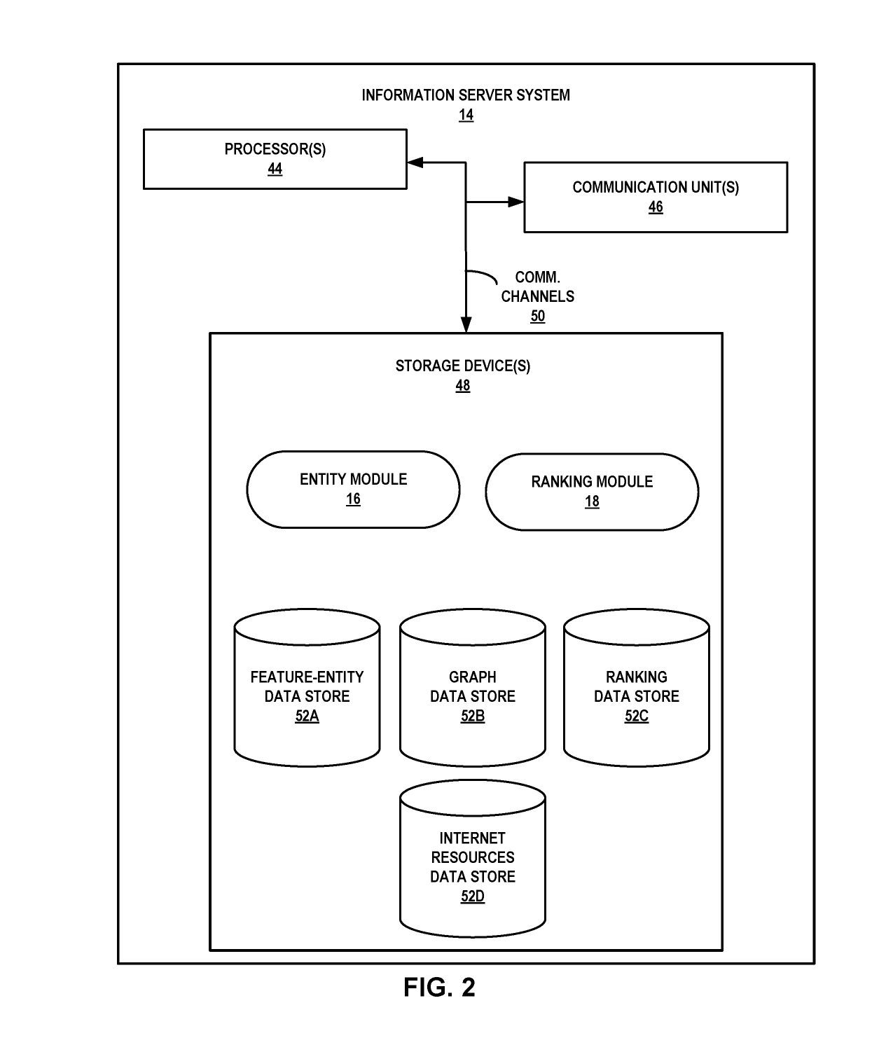

FIG. 2 is a block diagram illustrating ISS 14 as an example computing system configured to determine the level of relatedness of a set of entities, in accordance with one or more aspects of the present disclosure. FIG. 2 illustrates only one particular example of ISS 14, and many other examples of ISS 14 may be used in other instances and may include a subset of the components included in example ISS 14 or may include additional components not shown in FIG. 2.

ISS 14 provides computing device 2 with a conduit through which a computing device, such as computing device 2, may access a related entities service for automatically receiving information indicative of one or more related entities for an entity of interest or a feature of interest. As shown in the example of FIG. 2, ISS 14 includes one or more processors 44, one or more communication units 46, and one or more storage devices 48. Storage devices 48 of ISS 14 include entity module 16 and ranking module 18.

Storage devices 48 of ISS 14 further includes feature-entity data store 52A, graph data store 52B, ranking data store 52C, and Internet resources data store 52D (collectively, “data stores 52”). Communication channels 50 may interconnect each of the components 44, 46, and 48 for inter-component communications (physically, communicatively, and/or operatively). In some examples, communication channels 50 may include a system bus, a network connection, an inter-process communication data structure, or any other method for communicating data.

One or more communication units 46 of ISS 14 may communicate with external computing devices, such as computing device 2 of FIG. 1, by transmitting and/or receiving network signals on one or more networks, such as network 12 or Internet 20 of FIG. 1. For example, ISS 14 may use communication unit 46 to transmit and/or receive radio signals across network 12 to exchange information with computing device 2. Examples of communication unit 46 include a network interface card (e.g., such as an Ethernet card), an optical transceiver, a radio frequency transceiver, a GPS receiver, or any other type of device that can send and/or receive information. Other examples of communication units 46 may include short wave radios, cellular data radios, wireless Ethernet network radios, as well as universal serial bus (USB) controllers.

Storage devices 48 may store information for processing during operation of ISS 14 (e.g., ISS 14 may store data accessed by modules 16 and 18 during execution at ISS 14). In some examples, storage devices 48 are a temporary memory, meaning that a primary purpose of storage devices 48 is not long-term storage. Storage devices 48 on ISS 14 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 48, in some examples, also include one or more computer-readable storage media. Storage devices 48 may be configured to store larger amounts of information than volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or data associated with modules 16 and 18.

One or more processors 44 may implement functionality and/or execute instructions within ISS 14. For example, processors 44 on ISS 14 may receive and execute instructions stored by storage devices 48 that execute the functionality of modules 16 and 18. These instructions, when executed by processors 44, may cause ISS 14 to store information, within storage devices 48 during program execution. Processors 44 may execute instructions of modules 16 and 18 to extract a plurality of features associated with a plurality of entities from a plurality of Internet sources, and to determine a level of relatedness between each of the entities, to output a ranking of one or more related entities for a particular entity of interest or feature of interest. That is, modules 16 and 18 may be operable by processors 44 to perform various actions or functions of ISS 14 which are described herein.

The information stored at data stores 52 may be stored as structured data which is searchable and/or categorized. For example, one or more modules 16 and 18 may store data into data stores 52. One or more modules 16 and 18 may also provide input requesting information from one or more of data stores 52 and in response to the input, receive information stored at data stores 52. ISS 14 may provide access to the information stored at data stores 52 as a cloud based, data-access service to devices connected to network 12 or Internet 20, such as computing device 2. When data stores 52 contain information associated with individual users or when the information is generalized across multiple users, all personally identifiable information such as name, address, telephone number, and/or e-mail address linking the information back to individual people may be removed before being stored at ISS 14. ISS 14 may further encrypt the information stored at data stores 52 to prevent access to any information stored therein. In addition, ISS 14 may only store information associated with users of computing devices if those users affirmatively consent to such collection of information. ISS 14 may further provide opportunities for users to withdraw consent and in which case, ISS 14 may cease collecting or otherwise retaining the information associated with that particular user.

Entity module 16 may retrieve, receive, or otherwise obtain Internet resources, such as from Internet servers 22 via Internet 20 as well as resource information associated with the Internet resources, and may store the Internet resources as well as the resource information associated with the Internet resources into Internet resource data store 52D.

The Internet resources obtained by entity module 16 may, in some examples, be documents (e.g., web pages) obtained by crawling Internet 20 for documents. In some examples, entity module 16 may not store the Internet resources in Internet resource data store 52D. Instead, the Internet resources may be stored elsewhere, such as on one or more remote computing devices (not shown) with which entity module 16 may communicate via Internet 20.

Resource information associated with the Internet resources may include context information about Internet resources that may not be included in the body of the Internet resources themselves. For example, resource information associated with a particular Internet resource may include queries issued to an Internet search engine that results a visit to the Internet resource via a link to the Internet resource that is included in the search results. In another example, resource information associated with a particular Internet resource may include anchor text of a link to the Internet resource from another Internet resource. In another example, the resource information associated with a particular Internet resource may include a taxonomic categorization of the Internet resource.

The Internet resources obtained by entity module 16 may be associated with a plurality of entities, such that each entity may be associated with one or more Internet resources. An entity may be, in some examples, an event, a place, a person, a business, a movie, a restaurant, and the like. An entity may further be associated with one or more of a description, a location, and a time. The description of an entity may, in some examples, be the title of an event, the name of a business, and the like. The location may be a geographic location such as the location of the event, the location of a business, and the like. The time may, in some examples, be the time at which an event takes place.

An Internet resource that is associated with a particular entity may describe the particular entity. For example, if the particular entity is an event, an Internet resource that is associated with the particular entity may be a web page for the event, a social media post regarding the event, a web site for the venue at which the event is to be held, and the like.

Entity module 16 may extract, from at least the Internet resources obtained by entity module 16, a plurality of entities and may, for each entity of the plurality of entities, determine one or more Internet resources that are associated with the particular entity. Entity module 16 may, for each of the plurality of entities, extract one or more features associated with the entity from at least the one or more Internet resources that are associated with the particular entity and resource information associated with the one or more Internet resources. The one or more features associated with the entity may include contextual information that describes the entity. In some examples, features may include textual information, such as words, phrases, sentences, and the like. For example, entity module 16 may extract, from a web page associated with a musical concert, words and phrases such as “Beethoven,” “symphony,” “concerto,” “orchestra,” “conductor,” “pianist,” “concertmaster,” “violinist,” and the like as features that describe or are otherwise associated with the musical concert.

The features extracted by entity module 16 for a particular entity may be categorized into one or more feature categories that correspond to the types of information that describes the associated entity. The set of feature categories may include one or more of a title, a surround, a query, an anchor, and a taxonomy. One or more features extracted from a title or a heading of the one or more Internet resources (e.g., one or more web pages) associated with the entity may be categorized as belonging to a feature title category, and may comprise one or two sentences that describe the entity. One or more features that are extracted from the surrounding text included in the one or more Internet resources, such as the body of the one or more web pages for the associated with the entity, may be categorized as belonging to a surround feature category.

The query feature category may include one or more features extracted from queries issued to an Internet search engine that results a visit to the one or more Internet resources associated via the entity, via links to the one or more Internet resources that are included in the search results. For example, entity module 16 may categorize a query of “classical music concerts” that resulted in a visit to a web page for a musical concert as features “classical,” “music,” and “concerts” that belong in the query feature category.

The anchor feature category may include one or more features extracted from anchor text of links to the one or more Internet resources associated entity from another Internet resource. Thus, in one example, if a web page contains a “classical concert” anchor that links to the web page for an entity that is a musical concert, entity module 16 may categorize the anchor text of “classical concert” as features “classical” and “concert” that belong in the anchor feature category for the entity associated with the musical concert.

The taxonomy feature category may include one or more features extracted from a taxonomic categorization of the one or more Internet resources associated with the entity. Entity module 16 may perform taxonomic categorization of the Internet sources to label each of the one or more Internet resources associated with the entity as being associated with one or more categories, from higher level categories such as sports and arts to lower level categories such as golf and rock music.

Entity module 16 may, for each entity, associate a feature value with each different feature associated with a particular entity. The feature value associated with a feature that is associated with an entity may correspond to the number of times that the same feature is extracted from the one or more Internet resources associated with the entity and the resource information associated with the one or more Internet sources. For example, for an entity that is a musical event, the feature “concert” may appear many times, such as in the title of the one or more Internet resources and in the body of the Internet resources. Entity module 16 may de-duplicate the same events that are extracted multiple times from the one or more Internet resources associated with the entity and the resource information associated with the one or more Internet sources by associating a single instance of the resource with the entity, and by assigning that entity a feature value that corresponds to the number of times that the same feature is extracted from the one or more Internet resources associated with the entity and the resource information associated with the one or more Internet sources.

As a result of extracting features from the Internet resources and resource information associated from the Internet resources, entity module 16 may associate one or more features with each of a plurality of entities, where the one or more features may be textual information that describes or otherwise provides contextual information for the corresponding entity. By categorizing the features into feature categories, each entity may be associated with one or more of the feature categories and may, for each associated category, be associated with one or more features in that feature category. In some examples, an entity may be associated with features in each of the five feature categories described above. In other examples, an entity may be associated with features in fewer than all of the five feature categories described above. In additional examples, an entity may be associated with features in one or more additional feature categories other than the feature categories describe above.

Entity module 16 may, for each entity, perform feature processing to process the entities and the features extracted from the Internet resources. For example, the features may include textual information, such that entity module 16 may perform stemming (e.g., applying a Porter stemmer) of the features and may convert the stemmed features to unigram and bigram features.

Entity module 16 may also perform entity de-duplication, such as by de-duplicating entities having the same names or titles, and may perform feature merging to merge the features associated with the duplicate events. As discussed above, each feature associated with the duplicate events may have an associated feature value, which may correspond to the frequency in which those events appear in the respective feature categories. For example, if the word “jazz” is a feature that appears multiple times in the surround feature category for a particular event, the feature value for the feature “jazz” may correspond to the number of times the word “jazz” appears in the surrounding text included in the one or more Internet resources associated with the entity. To merge features of duplicate events, entity module 16 may determine the feature value of a feature to be merged as the sum the feature values of the same features of both entities if those features fall under the title, surround, query, and anchor feature categories. Entity module 16 may also determine the feature value of a feature to be merged as the max of the feature values of the same features of both entities for entities that fall under the taxonomy feature category.

Entity module 16 may also perform stop word removal and feature reweighing to reduce feature noise in information retrieval as a part of feature processing. Stop word removal may include both global stop word removal as well as local stop word removal. To perform global stop word removal, entity module 16 may determine feature frequency of each of the extracted features, which may be the number of entities that are associated with the particular feature. Entity module 16 may determine that features which have a relatively high feature frequency (e.g., features associated with more than a threshold number of entities, features in the top 10 percentage of associated feature frequencies, and the like) may be global stop words, and may remove those features from entities or otherwise disassociate those features with entities.

Entity module 16 may also perform local stop word removal, to remove local stop words. Local stop words may be frequent features for entities of a particular region that remain after performing global stop word removal. As discussed above, each entity may have an associated geographic location or geographic region. For example, when focusing on entities of a specific location, such as New York, many entities from New York may contain the phrase “New York,” which may not be removed during stop word removal. Entity module 16 may, for a specified geographic location (e.g., New York), perform local stop word removal to remove words or phrases that may appear frequently as features for entities in that particular geographic location. Thus, entity module 16 may perform local stop word removal for the associated geographic location of an entity by determining feature frequency within a specific area associated with the geographic location, and removing stop words associated with the geographic location.

Entity module 16 may further perform, for each entity, feature reweighing of the one or more features associated with the entity by determining a feature weight of each feature associated with the entity that is based at least in part on the feature frequency of each feature for the respective entity. In other words, entity module 16 may reweigh a particular feature associated with a particular entity based at least in part on the feature value of the particular feature as it pertains to the particular entity. If a feature is associated with multiple entities, entity module 16 may determine a separate feature weight for each feature-entity pair, such that such a feature may be associated with multiple feature weights, one for each entity with which it is associated.

Performing feature reweighing may include, for each entity, scaling down frequent features having a high feature value for the entity and scaling up features having a low feature value for the entity, due to the potentially skewed distribution of feature frequency even after performing stop word removal. For the frequency of each feature of an entity, entity module 16 may apply log normalized term frequency-inverse document frequency (TF-IDF) by log scaling the frequency and multiplying the log scaled frequency by its inverse document frequency to determine a weight for the particular feature j in entity i as follows:

$${weight}_{ij} = log ( 1 + {tf}_{ij} ) * log \frac{N}{{df}_{j}} ,$$

where weightᵢⱼ may be the feature weight of feature j associated with entity i, tfᵢⱼ may be the frequency of feature j in entity i, such as the feature value of the feature for the entity, N may be the collection size (i.e., the total number of entities), and dfⱼ may be the number of entities in which feature j appears. In this way, entity module 16 may, for each entity, determine a weight for each feature associated with a particular entity.

Entity module 16 may store indications of an association between entity, features, and feature categories for each entity extracted from the Internet resources into feature-entity data store 52A, as well as the feature weights for each feature associated with the entities. For example, for each entity, entity module 16 may store, as structured data, at least the one or more features associated with the structured data, the feature weight of each of the one or more features, and the one or more feature categories under which the one or more features fall. Entity module 16 may further store into feature-entity data store 52A any additional information associated with the entities, such as the geographical location associated with each of the entities, or any other suitable information.

Ranking module 18 may, for a particular entity, determine a ranking of one or more entities related to the particular entities. The ranking of one or more entities related to the particular entity may be an indication of the one or more entities that have a highest level of relatedness to the particular entity out of a set of entities stored in feature-entity data store 52A. If each entity in a set of entities each has an associated similarity score that indicates a level of relatedness between the respective entity and the particular entity, the one or more entities that are related to be the particular entity may be the one or more entities that have the highest similarity scores out of the set of entities with respect to the particular entity. In other words, given a random user that has an interest in the particular entity the one or more entities related to the particular entity may be the one or more entities that the same random user would be the most interested in out of a set of entities stored in feature-entity data store 52A.

In some examples, ranking module 18 may determine a level of relatedness (e.g., a similarity score) between each of the entities stored in feature-entity data store 52A. Thus, in this example, for each entity stored in feature-entity data store 52A, ranking module 18 may determine a level of relatedness between the particular entity and each other entity stored in feature-entity data store 52A.

In other examples, because a user that is interested in a particular entity may also be interested only in other entities that are within the same geographic area, instead of determining the level of relatedness between each of the entities stored in feature-entity data store 52A, ranking module 18 may instead determine the relatedness only between entities stored in feature-entity data store 52A that are within or associated with the same geographic region or location. Ranking module 18 may determine whether entities are within the same geographic region based at least in part on the geographic location associated with the entities. In this way, in this example, ranking module 18 may determine a level of relatedness (e.g., a similarity score) between each of a subset (e.g., fewer than all) of the entities stored in feature-entity data store 52A

In one example, ranking module 18 may perform a combiner technique to determine a ranking of one or more entities related to each of a set of entities. Ranking module 18 may perform the combiner technique to determine a level relatedness between each entity of a set of entities stored in feature-entity data store 52A. For example, ranking module 18 may determine a level relatedness between each entity of a set of entities associated with the same geographic region or geographic location stored in feature-entity data store 52A. For a particular entity, which may be referred to as a source entity, ranking module 18 may determine the level of relatedness between the source entity and another entity, which may be referred to as a target entity, by determining the level of similarity of features of the same set of feature categories between the source entity and the target entity

Assuming a list of k feature categories associated with the source entity and the target entity, F_{S}^{j} may be a set of features belonging to feature category j for source entity S, and F_{T}^{j} may be a set of features extracted from feature category j for target entity T. For a particular feature category j, ranking module 18 may determine a similarity score between source entity S and target entity T as sc(F_{S}^{j}, F_{T}^{j}), where sc( ) is a similarity score function, and where the similarity score corresponds to the level of similarity between the source entity and the target entity for that feature category.

More specifically, to determine the similarity score between source entity S and target entity T for a particular feature category, ranking module 18 may treat each entity as a distribution of features. To that end, ranking module 18 may utilize Jeffreys-Kullback-Leibler divergence, which may be a symmetric version of Kullback-Leibler divergence, to determine a measure of the difference between the distribution of features of the source and target entities. Given the set of features F_{S}^{j} and F_{T}^{j}, ranking module 18 may define the similarity between source entity S and target entity T for feature category j as sc(F_{S}^{j}, F_{T}^{j})=exp[−½(D(F_{S}^{j}∥F_{T}^{j})+D(F_{T}^{j}∥F_{S}^{j})], where D(•∥•) is the Kullback-Leibler divergence. In this way, ranking module 18 may perform the combiner technique to determine a similarity score for each feature category between a source entity and a target entity.

Ranking module 18 may perform the combiner technique to determine a similarity score between source entity S and target entity T for each of the k feature categories as sc(F_{S}¹, F_{T}¹), . . . sc(F_{S}^{k}, F_{T}^{k}). Based on the similarity score for each feature category between the source entity and the target entity, ranking module 18 may determine an overall similarity score between the source event and the target event as an aggregation of the similarity scores for each feature category between a source entity and a target entity. Specifically, ranking module 18 may, based on the similarity score for each of the feature categories, determine an overall similarity score between source entity S and target entity T as sc(S, T)=φ(sc(F_{S}¹, F_{T}¹), . . . sc(F_{S}^{k}, F_{T}^{k})), where φ may be an aggregation function.

The similarity score for source entity S and target entity T given feature category j may be denoted as Ranking module 18 may combine the similarity scores for each of the feature categories of source entity S and target entity T into a single ranking list by Reciprocal Rank Fusion. Given target entity T is associated with a similarity score of r_{S,T}^{j} with respect to source entity S, the overall similarity score between source entity S and target entity T of sc(S, T) may be expressed as

$$sc ( S , T ) = {\sum }_{j} \frac{1}{{r}_{S , T}^{j} + K} ,$$

where j may be each of the feature categories and where K may be a large predefined constant that reduces the impact of high rankings giving by outlier rankers. In one example, K may be 60.

Thus, ranking module 18 may, by performing the combiner technique, determine a level of relatedness between two entities based at least in part on an aggregation of the similarity between the features of the two entities. As discussed above, ranking module 18 may determine a level of relatedness between each of a set of entities out of the entities stored in feature-entity data store 52A, and may store an indication of the level of relatedness between each of a set of entities determined by ranking module 18 into ranking data store 52C. For example, ranking data store 52C may store indications of pairs of entities along with an indication of the associated level of relatedness, such as a similarity score, into ranking data store 52C.

In other examples, ranking module 18 may determine, for each of a set of entities, based on the level of relatedness between each of a set of entities out of the entities stored in feature-entity data store 52A, a ranking of one or more entities that are related to the particular entity, such as a ranking of one or more entitles having the highest level of relatedness to the particular entity out of the set of entities, and may store such indications of the ranking of one or more entities that are related to each entity in the set of entities into ranking data store 52C.

In this way, ISS 14 may receive an indication of an entity from, for example, computing device 2, determine, from the data stored in ranking data store 52C, a ranking of one or more entities that are related to the particular entity, and transmit, to computing device 2, an indication of the ranking of one or more entities that are related to the particular entity. In one example, the indication of an entity that ISS 14 receives from computing device 2 may indicate a name associated with the entity, such as “Miles Davis” or “Beethoven's 5^{th} Symphony.” Ranking module 18 may utilize the name associated with the entity to index into ranking data store 52C to find the entity associated with that name, and may determine a location within ranking data store 52C where the ranking of indication of the one or more entities that are related to the particular entity is stored. Ranking module 18 may retrieve the indication of the ranking of one or more entities that are related to the particular entity. ISS 14 may format the retrieved indication of the ranking of one or more entities that are related to the particular entity into any suitable structured data format for transmitting the indication of the ranking of one or more entities, such as JSON or XML, and may output the indication of the one or more entities to computing device 2, such as via network 12 or internet 20.

In other examples, instead of retrieving the ranking of one or more entities that are related to the particular entity from ranking data store 52C, ISS 14, may, in response to receiving an indication of an entity from, for example, computing device 2, determine a ranking of one or more entities that are related to the particular entity on-the-fly, using the combiner technique described herein, and output an indication of the ranking of one or more entities to computing device 2, such as via network 12 or internet 20 using the techniques described herein.

In another example, ISS 14 may receive an indication of a query from, for example, computing device 2. A query may be textual data, such as a word, a phrase, and the like, that computing device 2 may receive as input. For example, a query may be search phrase for one or more entities that are related to the query. In response to receiving the indication of the query, computing device 2 may, via ranking module 18, determine a ranking of one or more entities that are related to the query, and may output to computing device 2 an indication of the ranking of one or more entities that are related to the query.

Specifically, responsive to computing device 2 receiving an indication of a query, such as “marathon,” ranking module 18 may, based at least in part on performing the combiner technique described herein, determine a ranking of one or more related entities to the search phrase. Ranking module 18 may determine a set of one or more entities each having an entity name or title that matches the issued query as a seed set S. Ranking module 18 may, using these seed entities, determine one or more entities related to each entity within seed set S, inclusive of the seed entity, as a set of candidate entities C_{S}. Ranking module 18 may rank the candidate entities within set of candidate entities C_{S} by their respective similarity scores. If an entity within the set of candidate entities is retrieved multiple times from different seed entities, because ranking module 18 determines that the entity is related to more than one of the entities in the seed set S, ranking module 18 may add up its similarity scores to result in a single similarity score for that entity. More formally, the similarity of target entity T to query Q may be defined as sc(Q,T)= [symbol] sc(S,T), where sc(S, T) may be computed by ranking module 18 according to the combiner technique disclosed herein. Ranking module 18, may determine from the similarity scores associated with the entities in candidate entities C_{S}, a ranking of one or more entities related to the query, and may output an indication of the ranking of one or more entities to computing device 2, such as via network 12 or internet 20 using the techniques described herein.

In another example, ranking module 18 may perform an expander technique to determine a ranking of one or more entities related to each of a set of entities. Ranking module 18 may perform the expander technique to determine a level relatedness between each entity of a set of entities stored in feature-entity data store 52A. Specifically, ranking module 18 may perform the expander technique to determine a level of relatedness between a given pair of two entities based at least in part on determining the semantic relatedness between features of the two entities. For example, ranking module 18 may determine that two entities are highly similar if they are both highly similar to a third party entity, even if the two entities have a relatively low measure of similarity based on performing the combiner technique discussed above.

To this end, ranking module 18 may generate a feature-entity bipartite graph (discussed in further detail with respect to FIGS. 3A-3C) in which features and entities are represented as nodes. Specifically, the graph may include a plurality of nodes, including feature nodes representing a plurality of features and entity nodes representing a plurality of entities. Each of the entity nodes in the graph may be connected to one or more of the feature nodes via one or more edges each having an edge weight, where an entity node may be connected to a feature node if the entity represented by the entity node is associated with the feature represented by the feature node.

Ranking module 18 may store an indication of the feature-entity bipartite graph generated by ranking module 18 as data into graph data store 52B, which may include one or more data structures such as arrays, database records, registers, and the like. For example, ranking module 18 may store data indicative of the plurality of feature nodes, the plurality of entity nodes, the one or more edges that connects each of the entity nodes to one or more of the feature nodes, the edge weights of the one or more edges, and the like into graph data store 52B. In one example, for each entity node of the feature-entity bipartite graph, ranking module 18 may store into graph data store 52B data indicative of the entity represented by the entity node, data indicative of the one or more feature nodes connected to the entity node, and/or the values of the edge weights of the one or more edges that connect the entity node to each of the one or more feature nodes. Similarly, for each feature node of the feature-entity bipartite graph, ranking module 18 may store into graph data store 52B data indicative of the feature represented by the feature node.

Throughout this disclosure, the terms feature-entity bipartite graph or graph may be synonymous with the data stored in graph data store 52B that are indicative of the feature-entity bipartite graph. In other words, while this disclosure may describe operations that are performed by modules 16 and 18 on the feature-entity bipartite graph, it should be understood that modules 16 and 18 may in fact be operating on data stored in graph data store 52B that are indicative of the feature-entity bipartite graph, such as the feature nodes, entity nodes, edges, edge weights, connections between each of the entity nodes to one or more of the feature nodes via the edges, and the like, that make up the feature-entity bipartite graph.

Each edge that connects an entity node to a feature node may have an edge weight that corresponds to the feature weight for the feature represented by the feature node as associated with the entity that is represented by the connected entity node, as discussed above with respect to feature reweighing. In some examples, in the graph, entity nodes may not be connected to other entity nodes, and feature nodes may not be connected to other feature nodes. If a feature for an entity appears in multiple feature categories, ranking module 18 may collapse those feature in to a single feature represented by a single feature node that is connected to the entity node representing the entity. For example, ranking module 18 may collapse the feature “movie” that is categorized in both the query feature category and the title feature category for a particular entity into a single feature that is represented by a single feature node, and may sum the feature weights of the feature in the two features into a single edge weight for the edge the connects the entity node to the feature node, thereby reducing feature dimension and mitigating feature sparsity issues.

Conceptually speaking, ranking module 18 may determine the relatedness of a pair of entities, such as between source entity S and target entity T as sc(S,T)=φ(sc(F_{S}¹, F_{T}¹, [symbol] _{S,T}F_{N}¹), . . . , sc(F_{S}^{k}, F_{T}^{k}, [symbol] _{S,T} F_{N}^{k})), where [symbol] _{S,T} is the neighborhood of entity nodes associated with entities S and T within the graph, and where [symbol] _{S,T} may model the entire graph structure to find related entity pairs, connected via multiple hops in the graph (e.g., not just immediate neighborhood).

In other words, two entity nodes may within an immediate neighborhood of each other in the graph because they both connect to the same feature node. However, ranking module 18 may nevertheless determine that two entities are related even if their respective entity nodes are not within each other's immediate neighborhood, based on the similarity between the features of the source and target entities along with the features of another entity represented by an entity node that is within the neighborhood of the entity nodes representing the source and target entities. Thus, ranking module 18 may determine, for a particular source entity, that it is related to a target entity, even if the entity nodes representing the source entity and the target entity are not connected to the same feature node, as long as the entity nodes representing the source entity and the target entity are related to another entity represented by an entity node that is in the neighborhood of the entity nodes representing the source and target entities.

Upon generating the feature-entity bipartite graph, ranking module 18 may perform label propagation to propagate labels across the feature-entity bipartite graph, to associate a distribution of labels with each of the plurality of nodes, so that each node in the graph may be associated with a distribution of labels. Thus, each feature node and each entity node in the graph may be associated with a distribution of labels as a result of label propagation. As discussed above, performing label propagation across the feature-entity bipartite graph may include ranking module 18 operating on the data store in graph data store 52B that are indicative of the feature-entity bipartite graph to perform the label propagation.

Each of the labels that ranking module 18 propagates across the graph may indicate one of the entities represented as nodes in the graph, such that a distribution of labels associated with a node in the graph may be a distribution of one or more entities that are related to entity or feature that is represented by the particular node. Further, the distribution of labels associated with a node in the graph may indicate the level of relatedness of each of the one or more entities in the distribution of one or more entities to the entity or feature that is represented by the particular node, such that the distribution of labels associated with the node in the graph may be an indication of a ranking of the relatedness of the one or more entities related to the entity or feature that is represented by the particular entity node of feature node.

To initiate label propagation across the feature-entity bipartite graph, ranking module 18 may associate a label with each entity node by seeding each of the plurality of entity nodes with one of a plurality of labels. Such labels initially associated with the entity nodes may be known as seed labels. The label associated with a particular entity node may identify the entity represented by the entity node, so that each one of the labels seeded by ranking module 18 may identify a corresponding one of the entity nodes. Each label may be an identity label, such that an entity may be a relevant label for itself. Thus, an entity node that represents entity A may be associated with a label of “entity A,” which may be the title of the associated entity.

Ranking module 18 may perform label propagation to propagate the labels associated with the entity nodes across the graph, such that each node may be associated with a distribution of one or more of the labels. To perform label propagation, ranking module 18 may determine the distribution of labels associated with each node of the graph as an optimal solution that minimizes an objective function.

Given the feature-entity bipartite graph, the objective function may simultaneously minimize the following over all nodes in the graph: squared loss between true and induced label distribution, regularization term that penalizes neighboring feature nodes that have different label distribution from this entity node, and regularization term that smooths the induced label distribution towards the prior distribution, which is usually a uniform distribution in practice.

More specifically, for each entity node i with its feature neighbors [symbol] (i), where feature neighbors of an entity node may be the feature nodes that are connected via edges directly to the entity node, ranking module 18 may determine the distribution of labels associated with the entity node as the optimal solution to minimize the objective function of ∥Ŷ_{ι}−Yᵢ∥²+μₙₚ [symbol] wᵢⱼ∥Ŷ_{ι}−Ŷ_{J}∥²+μₚₚ∥Ŷ_{ι}−U∥², where is Ŷ_{ι} is the learned label distribution for entity node i, Yᵢ is the true label distribution, μₙₚ is the predefined penalty for neighboring nodes with divergent label distributions, Ŷⱼ is the learned label distribution for feature neighbor j, wᵢⱼ is the weight of feature j in entity i, μₚₚ is the penalty for label distribution deviating from the prior a uniform distribution U. In some examples, μₙₚ may be 0.5, and μₚₚ may be 0.001.

Thus, in this example, ∥Ŷ_{ι}−Yᵢ∥² may be the squared loss between a true distribution of labels associated with the entity node and a learned distribution of labels associated with the entity node, where Yᵢ is the true distribution of labels associated with the entity node i and Ŷ_{ι} is the learned distribution of labels for entity node i. The true distribution of labels associated with the entity node i may be the label that ranking module 18 seeds for entity node i, while the learned distribution of labels may be the distribution of labels that is associated with entity node i as a result of ranking module 18 performing label propagation over the graph.

Further, μₙₚ may be a first regularization term that penalizes neighboring feature nodes that are associated with different distributions of labels from the distribution of labels associated with the entity node, where [symbol] ₍ᵢ₎wᵢⱼ∥Ŷ_{ι}−Ŷ_{J}∥² represents the difference in the distribution of labels associated with neighboring feature nodes from the distribution of labels associated with the entity node i, where Ŷ_{J} may be the distribution of labels that is associated with a feature node j that is connected to entity node i via an edge having an edge weight of wᵢⱼ as a result of ranking module 18 performing label propagation over the graph. In addition, μₚₚ may be a second regularization term that smooths the learned distribution of labels associated with the entity node towards a prior distribution of labels, by multiplying μₚₚ with ∥Ŷ_{ι}−U∥².

Ranking module 18 may determine the distribution of labels associated with a feature node as the optimal solution to minimize the objective function of μₙₚ [symbol] wᵢⱼ∥Ŷ_{J}−Ŷ_{ι}∥²+μₚₚ∥Ŷ_{J}−U∥² for each feature node j with its entity neighbors [symbol] (j) that are connected via edges directly to feature node j. The objective function for a feature node is similar to the objective function for an entity node, except that there is no first term, as ranking module 18 does not provide seed labels for feature nodes. Thus, μₙₚ may be a first regularization term that penalizes neighboring entity nodes that are associated with different distributions of labels from the distribution of labels associated with the feature node, where [symbol] ₍ⱼ₎wᵢⱼ∥Ŷ_{J}−Ŷ_{ι}∥² may represent the difference in the distribution of labels associated with neighboring entity nodes from the distribution of labels associated with the feature node j. Further, μₚₚ may be a second regularization term that smooths the learned distribution of labels associated with the feature node towards a prior distribution of labels by multiplying μₚₚ with ∥Ŷ_{J}−U∥².

Ranking module 18, by performing label propagation, may determine the distributions of labels for the entity nodes and the feature nodes of the graph as an optimal solution that minimizes the objective functions over the entirety of the graph. Thus, while ranking module 18 may not minimize the objective functions for each individual entity node or feature node, ranking module 18 may minimize the overall objective functions for the feature nodes and entity nodes making up the graph.

Ranking module 18 may perform unsupervised machine learning to perform the label propagation discussed herein. Specifically, given a feature-entity bipartite graph in which a plurality of entity nodes are connected to a plurality of feature nodes via edges having associated edge weights, where the plurality of entity nodes are seeded with a plurality of labels, ranking module 18 may perform label propagation over multiple iterations (e.g., 5 iterations) without additional input to determine a distribution of labels for each node of the graph to minimize the objective functions described above.

By performing label propagation, ranking module 18 may associate a distribution of labels with each node in a graph. Each of the distribution of labels associated with a node may include an indication of a ranking of one or more entities that are related to an entity or a feature represented by the associated entity node or feature node. Because each label in the graph may identify a particular entity represented by an entity node, a distribution of labels associated with a node may indicate the entity names of one or more entities that are related to a particular feature or entity represented by the node. Further, the distribution of labels associated with a node may also indicate the level of relatedness of the entities to a particular feature or entity represented by the node. In this way, the distribution of labels may indicate a ranking of one or more entities that are related to an entity or a feature represented by the associated entity node or feature node. Ranking module 18 may store an indication of each entity and each feature represented in the graph into ranking data store 52C, including an indication of a ranking (by the level of relatedness) of one or more entities that are related to the entity or feature.

Thus, ISS 14 may receive incoming data that is indicative of an entity or an indication of a feature from, for example, computing device 2 via network 12 or Internet 20, determine, from the data stored in ranking data store 52C, an indication of a ranking of one or more entities that are related to the entity or feature, and transmit, to computing device 2, outgoing data that includes an indication of the ranking of one or more entities that are related to the particular entity or feature. In one example, the indication of an entity that ISS 14 receives from computing device 2 may indicate a name associated with the entity, such as “Miles Davis” or “Beethoven's 5^{th} Symphony.” Ranking module 18 may utilize the name associated with the entity to index into ranking data store 52C to find the entity associated with that name, and may determine a location within ranking data store 52C where the indication of the ranking of the one or more entities that are related to the particular entity is stored. Ranking module 18 may retrieve the indication of the ranking of one or more entities that are related to the particular entity. ISS 14 may format the retrieved indication of the ranking of one or more entities that are related to the particular entity into any suitable structured data format for transmitting the indication of the ranking of one or more entities, such as JSON or XML, and may output the indication of the one or more entities to computing device 2, such as via network 12 or internet 20.

In another example, ISS 14 may receive incoming data that is indicative of a query from, for example, computing device 2. A query may be textual data, such as a word, a phrase, and the like, that computing device 2 may receive as input. For example, a query may be search phrase for one or more entities that are related to the query. In response to receiving the indication of the query, computing device 2 may, via ranking module 18, determine a ranking of one or more entities that are related to the query, and may output to computing device 2 an indication of the ranking of one or more entities that are related to the query.

Given an indication of a query, such as “marathon,” ranking module 18 may determine a ranking of one or more related entities to the query. Ranking module 18 may treat the query as a feature, such as by mapping the text of the query to the text of a feature, to thereby

determinesc(Q,T)=Σ_{FεF}_{_{Q}}φ(sc(F_{S}¹,F_{T}¹, [symbol] _{S,T}F_{N}¹), . . . ,sc(F_{S}^{k},F_{T}^{k}, [symbol] _{S,T}F_{N}^{k})),

where F_{Q} may be the set of all of the features that map to query Q. Specifically, because each feature is associated with a distribution of labels that are indicative of a ranking of one or more entities related to the feature, ranking module 18 may determine the particular feature to which the query maps, index into ranking data store 52C to find the particular feature, and may determine a location within ranking data store 52C where the indication of the ranking of the one or more entities that are related to the particular feature is stored. Ranking module 18 may retrieve the indication of the ranking of one or more entities that are related to the particular feature. ISS 14 may format the retrieved indication of the ranking of one or more entities that are related to the particular feature into any suitable structured data format for transmitting the indication of the ranking of one or more entities, such as JSON or XML, and may output the indication of the one or more entities to computing device 2, such as via network 12 or internet 20.

FIGS. 3A-3C are block diagrams each illustrating an example feature-entity bipartite graph that ranking module 18 may construct to perform the expander technique according to aspects of the present disclosure. As shown in FIG. 3A, ranking module 18 may generate feature-entity bipartite graph 80 that includes entity nodes 84A and 84B connected to feature nodes 84D-84F connected via edges 86A-86F. Ranking module 18 may seed entity nodes 82A and 84B with labels 88A and 88B respectfully. Each of edges 86A-86F may have an associated edge weight (not shown).

Ranking module 18 may perform machine learning over graph 90 by exploiting the idea of label propagation, which is a graph-based learning technique that uses the information associated with each labeled seed node and propagates these labels over the graph in a principled and iterative manner. Label propagation may utilize two input sources: graph 80 and the seed labels 88A and 88B. Ranking module 18 may propagate the seed labels 88A and 88B based on the provided graph structure over graph 80, to associate a distribution of seed labels for each of nodes 84A-84F in the graph 80 as an optimal solution that minimizes an objective function.

Ranking module 18 may perform label propagation over multiple iterations to associate a distribution of seed labels for each of nodes 84A-84F in the graph 80 as an optimal solution that minimizes an objective function. FIG. 3B shows a first iteration of label propagation over graph 80. As shown in FIG. 3B, after a first iteration of label propagation, ranking module 18 may associate distribution of labels 82A-82F with nodes 84A-84F, respectively. Ranking module 88 may also distribute labels 88A and 88B across graph 80 such that distribution of labels 82A-82F may include indications of one or both labels 88A and 88B. Each distribution of labels may include an indication of one or more related entities as well as an indication of the level of relatedness between the entity or feature represented by the node and each of the one or more related entities. For example, distribution of labels 82D associated with feature node 84D includes indications of entities Science Fiction Movies and Science Fiction Films, and includes an indication of the relatedness between those entities and the feature associated with feature node 84D on a 0 to 1.0 scale, where the larger the score indicates a higher level of similarity.

Ranking module 18 may further iterate performance of label propagation over graph 80. FIG. 3C shows a further iteration of label propagation over graph 80. As shown in FIG. 3C, after further iteration of field propagation, ranking module 18 may further modify the distribution of labels associated with one or more of nodes 84A-84F to determine a more optimized solution that minimizes an objective function over graph 80. For example, distribution of nodes 82C now includes indications of entities Science Fiction Movies and Science Fiction Films, and includes an indication of the relatedness between those entities and the feature associated with feature node 84D on a 0 to 1.0 scale, where the larger the score indicates a higher level of similarity.

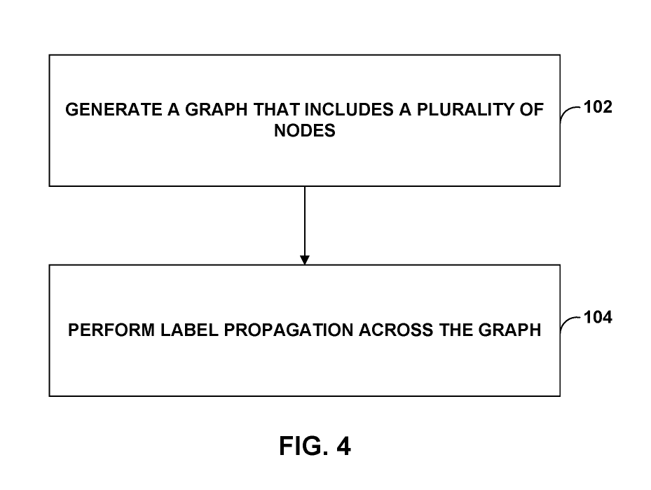

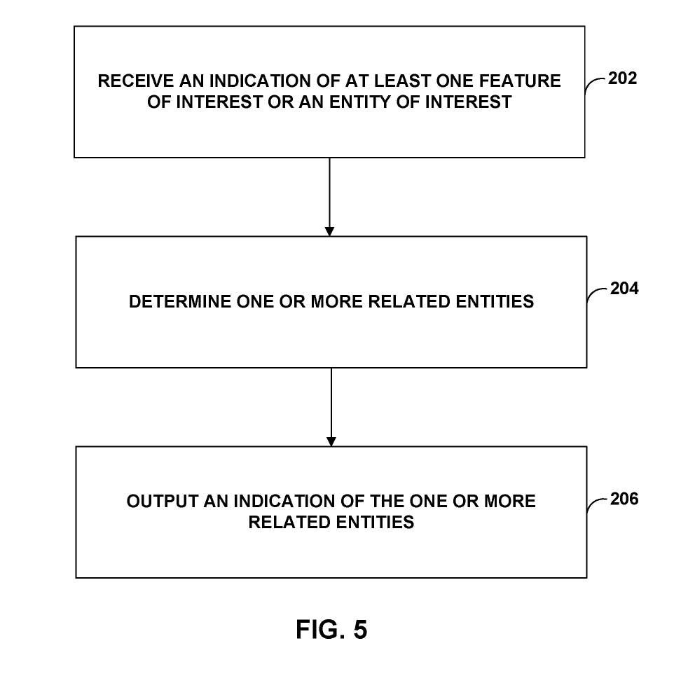

FIG. 4 is a flowchart illustrating an example process for to determining related entities, in accordance with one or more aspects of the present disclosure. In some examples, the process may be performed by one or more of ISS 14, entity module 16, and ranking module 18 shown in FIGS. 1 and 2. In some examples, the process may be performed with additional modules or components shown in FIGS. 1-2. For the purposes of illustration only, in one example, the process is performed by ISS 14 shown in FIG. 2. As shown in FIG. 4, the process may include generating, by ranking module 18, a graph, such as graph 80, that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes (102). The process may further include performing, by ranking module 18, label propagation to propagate a plurality of labels across the graph to associate a distribution of labels with each of the plurality of nodes (104). In some examples, ISS 14 may be configured to receive an indication of at least one of a feature of interest or an entity of interest. In some examples, ISS 14 may be configured to output an indication of one or more related entities that are related to the feature of interest or the entity of interest.

In some examples, the process may further include seeding, by ranking module 18, each of the plurality of entity nodes with a respective one of the plurality of labels, wherein each one of the labels identifies a corresponding one of the plurality of entity nodes. In some examples, performing the label propagation may further include performing, by ranking module 18, the label propagation to determine the distribution of labels associated with each of the plurality of nodes as an optimal solution that minimizes an objective function.

In some examples, the objective function is minimized for an entity node of the plurality of feature nodes, and wherein the objective function comprises: a squared loss between a true distribution of labels associated with the entity node and a learned distribution of labels associated with the entity node; a first regularization term that penalizes neighboring feature nodes that are associated with different distributions of labels from the distribution of labels associated with the entity node; and a second regularization term that smooths the learned distribution of labels associated with the entity node towards a prior distribution of labels.

In some examples, the objective function is minimized for a feature node of the plurality of feature nodes, and wherein the objective function comprises: a first regularization term that penalizes neighboring entity nodes that are associated with different distributions of labels from the distribution of labels associated with the feature node; and a second regularization term that smooths the learned distribution of labels associated with the feature node towards a prior distribution of labels.

In some examples, each of the distribution of labels includes an indication of a ranking of one or more entities that are related to an entity or a feature represented by an associated entity node or feature node. In some examples, the indication of the ranking of the one or more entities that are related to the entity or the feature represented by the associated node comprises an indication of a level of relatedness of each of the one or more entities to the entity or the feature represented by the associated entity node or feature node.

In some examples, the process further includes connecting, by ranking module 18 via one or more edges of the graph, each of the plurality of entity nodes in the graph that represent a corresponding entity with one or more of the plurality of feature nodes in the graph that represent one or more features associated with the corresponding entity. In some examples, the process may further include associating, by ranking module 18, one or more weights to the one or more edges.

In some examples, the process may further include extracting, by entity module 16 from a plurality of Internet resources associated with the plurality of entities, the plurality of features associated with the plurality of entities. In some examples, the plurality of entities are associated with a same geographic area.

FIG. 5 is a flowchart illustrating an example process for to determining related entities, in accordance with one or more aspects of the present disclosure. In some examples, the process may be performed by one or more of ISS 14, entity module 16, and ranking module 18 shown in FIGS. 1 and 2. In some examples, the process may be performed with additional modules or components shown in FIGS. 1-2. For the purposes of illustration only, in one example, the process is performed by ISS 14 shown in FIG. 2. As shown in FIG. 5, the process may include receiving, by communication units 46 of ISS 14, an indication of at least one of a feature of interest or an entity of interest (202). The process may further include determining, by one or more processors 44 of ISS 14, one or more related entities that are related to the feature of interest or the entity of interest based at least in part on a respective distribution of labels associated with one of a plurality of feature nodes in a graph that represents the feature of interest or one of a plurality of entity node in the graph that represents the entity of interest, wherein the graph includes a plurality of node, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes, and wherein a plurality of labels are propagated via label propagation across the graph to associate a distribution of labels with each of the plurality of nodes (204). The process may further include outputting, by communication units 46 of ISS 14 and for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest (206).

In some examples, receiving the indication of the at least one of the feature of interest or the entity of interest further comprises receiving, by ISS 14 via a network 12 and from a remote computing device 2, incoming data that is indicative of the at least one of the feature of interest or the entity of interest, and outputting, by ISS 14 and for the at least one of the feature of interest or the entity of interest, the indication of the one or more related entities that are related to the feature of interest or the entity of interest further comprises sending, by ISS 14 via the network 12 to the remote computing device 2, outgoing data that includes the indication of the one or more related entities that are related to the feature of interest or the entity of interest.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
generating, by a computing device, a graph that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes;
performing, by the computing device, label propagation to propagate a plurality of labels across the graph to associate a distribution of labels with each of the plurality of nodes;
wherein the computing device is configured to:
receive an indication of at least one of a feature of interest or an entity of interest, and
output, for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

2. The method of claim 1, wherein performing, by the computing device, the label propagation further comprises:
seeding, by the computing device, each of the plurality of entity nodes with a respective one of the plurality of labels, wherein each one of the labels identifies a corresponding one of the plurality of entity nodes.

3. The method of claim 2, wherein performing, by the computing device, the label propagation further comprises:
performing, by the computing device, the label propagation to determine the distribution of labels associated with each of the plurality of nodes as an optimal solution that minimizes an objective function.

4. The method of claim 3, wherein the objective function is minimized for an entity node of the plurality of feature nodes, and wherein the objective function comprises:
a squared loss between a true distribution of labels associated with the entity node and a learned distribution of labels associated with the entity node;
a first regularization term that penalizes neighboring feature nodes that are associated with different distributions of labels from the distribution of labels associated with the entity node; and
a second regularization term that smooths the learned distribution of labels associated with the entity node towards a prior distribution of labels.

5. The method of claim 3, wherein the objective function is minimized for a feature node of the plurality of feature nodes, and wherein the objective function comprises:
a first regularization term that penalizes neighboring entity nodes that are associated with different distributions of labels from the distribution of labels associated with the feature node; and
a second regularization term that smooths the learned distribution of labels associated with the feature node towards a prior distribution of labels.

6. The method of claim 1, wherein each of the distribution of labels includes an indication of a ranking of one or more entities that are related to an entity or a feature represented by an associated entity node or feature node.

7. The method of claim 6, wherein the indication of the ranking of the one or more entities that are related to the entity or the feature represented by the associated node comprises an indication of a level of relatedness of each of the one or more entities to the entity or the feature represented by the associated entity node or feature node.

8. The method of claim 1, further comprising:
connecting, by the computing device via one or more edges of the graph, each of the plurality of entity nodes in the graph that represent a corresponding entity with one or more of the plurality of feature nodes in the graph that represent one or more features associated with the corresponding entity.

9. The method of claim 8, further comprising:
associating, by the computing device, one or more weights to the one or more edges.

10. The method of claim 1, further comprising:
extracting, by the computing device from a plurality of Internet resources associated with the plurality of entities, the plurality of features associated with the plurality of entities.

11. The method of claim 1, wherein the plurality of entities are associated with a same geographic area.

12. A computing system comprising:
a memory; and
at least one processor communicatively coupled to the memory, the at least one processor being configured to:
generate a graph to be stored in the memory that includes a plurality of nodes, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes; and

13. The computing system of claim 12, wherein the at least one processor is further configured to:
seed each of the plurality of entity nodes with a respective one of the plurality of labels, wherein each one of the labels identifies a corresponding one of the plurality of entity nodes.

14. The computing system of claim 13, wherein the at least one processor is further configured to:
performing, by the computing device, the label propagation to determine the distribution of labels associated with each of the plurality of nodes as an optimal solution that minimizes an objective function.

15. The computing system of claim 14, wherein the objective function is minimized for an entity node of the plurality of feature nodes, and wherein the objective function comprises:
a squared loss between a true distribution of labels associated with the entity node and a learned distribution of labels associated with the entity node;
a first regularization term that penalizes neighboring feature nodes that are associated with different distributions of labels from the distribution of labels associated with the entity node; and
a second regularization term that smooths the learned distribution of labels associated with the entity node towards a prior distribution of labels.

16. A method comprising:
receiving, by a computing device, an indication of at least one of a feature of interest or an entity of interest;
determining, by the computing device, one or more related entities that are related to the feature of interest or the entity of interest based at least in part on a respective distribution of labels associated with one of a plurality of feature nodes in a graph that represents the feature of interest or one of a plurality of entity node in the graph that represents the entity of interest, wherein the graph includes a plurality of node, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes, and wherein a plurality of labels are propagated via label propagation across the graph to associate a distribution of labels with each of the plurality of nodes; and
outputting, by the computing device and for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

17. The method of claim 16, wherein:
receiving the indication of the at least one of the feature of interest or the entity of interest further comprises receiving, by the computing device via a network and from a remote computing device, incoming data that is indicative of the at least one of the feature of interest or the entity of interest; and
outputting, by the computing device and for the at least one of the feature of interest or the entity of interest, the indication of the one or more related entities that are related to the feature of interest or the entity of interest further comprises sending, by the computing device via the network to the remote computing device, outgoing data that includes the indication of the one or more related entities that are related to the feature of interest or the entity of interest.

18. A computing system comprising:
a memory; and
at least one processor communicatively coupled to the memory, the at least one processor being configured to:
receive an indication of at least one of a feature of interest or an entity of interest;
determine one or more related entities that are related to the feature of interest or the entity of interest based at least in part on a respective distribution of labels associated with one of a plurality of feature nodes in a graph that represents the feature of interest or one of a plurality of entity node in the graph that represents the entity of interest, wherein the graph includes a plurality of node, wherein the plurality of nodes includes a plurality of entity nodes representing a plurality of entities and a plurality of feature nodes representing a plurality of features, and wherein each of the plurality of entity nodes is connected in the graph to one or more of the plurality of feature nodes, and wherein a plurality of labels are propagated via label propagation across the graph to associate a distribution of labels with each of the plurality of nodes; and
output, for the at least one of the feature of interest or the entity of interest, an indication of one or more related entities that are related to the feature of interest or the entity of interest, wherein outputting the indication of the one or more related entities is based at least in part on the respective distribution of labels associated with one of the plurality of feature nodes that represents the feature of interest or one of the plurality of entity node that represents the entity of interest.

19. The computing system of claim 18, wherein the at least one processor is further configured to:
receive, via a network and from a remote computing device, incoming data that is indicative of the at least one of the feature of interest or the entity of interest; and
send, via the network to the remote computing device, outgoing data that includes the indication of the one or more related entities that are related to the feature of interest or the entity of interest.
